(19) United States
(12) Patent Application Publication
(10) Pub. No.: US 2026/0038138 A1
(43) Pub. Date: Feb. 5, 2026

(54) HOPPER FILLING AMOUNT MANAGEMENT SYSTEM AND CRANE CONTROL SYSTEM FOR GARBAGE DISPOSAL FACILITY

(71) Applicants: TOSHIBA DIGITAL SOLUTIONS CORPORATION, Kawasaki-shi (JP); KURITA WATER INDUSTRIES LTD., Tokyo (JP)

(72) Inventors: Tadasuke ITOU, Ota Tokyo (JP); Susumu FUKUE, Kawagoe Saitama (JP); Io OZAWA, Yokohama Kanagawa (JP); Shouhei KUDOU, Fuchu Tokyo (JP)

(73) Assignees: TOSHIBA DIGITAL SOLUTIONS CORPORATION, Kawasaki-shi (JP); KURITA WATER INDUSTRIES LTD., Tokyo (JP)

(21) Appl. No.: 19/286,774

(22) Filed: Jul. 31, 2025

(30) Foreign Application Priority Data
Aug. 1, 2024 (JP) 2024-125859

(51) Int. Cl. G06T 7/62; B66C 13/48; G06T 7/136

(52) U.S. Cl. CPC G06T 7/62; B66C 13/48; G06T 7/136; G06T 2207/20224

(57) ABSTRACT

[PROBLEM] To provide a hopper filling amount management system capable of easily and accurately determining a filling amount within a hopper.

[SOLVING MEANS]A hopper filling amount management system according to an embodiment manages a filling amount of garbage within a hopper (H) configured to receive the garbage loaded by a crane (C). The hopper filling amount management system includes an imaging apparatus (P) configured to capture images of the hopper (H), and a management apparatus (100) configured to calculate the filling amount based on the captured images output from the imaging apparatus (P). The management system (100) includes a hopper filling amount detection section (112) configured to set, as a reference image, a first captured image showing the hopper with no garbage loaded therein before operation, to create a difference image showing a difference between the reference image and a second captured image showing the hopper after start of the operation, and to calculate the filling amount based on the difference image.

### TECHNICAL FIELD

An embodiment of the present invention relates to a technique for managing the filling amount of garbage to be loaded into a hopper.

### BACKGROUND ART

Garbage disposal facilities have a mechanism in which garbage is loaded into a hopper by a crane and then moved downward through the hopper to the next step (for example, into an incinerator). The garbage during the movement to the next step undergoes control for continuous feeding and control for preventing overflow from the hopper.

Patent Documents 1 and 2 disclose a technique relating to automatic control of cranes in garbage disposal facilities. Patent Documents 1 and 2 achieve the automatic control of cranes by measuring the volume or the height of garbage within a garbage pit with sensors and/or cameras.

### PRIOR ART DOCUMENTS

### Patent Documents

[Patent Document 1] Japanese Patent Laid-Open No. 2006-44904
[Patent Document 2] Japanese Patent Laid-Open No. 2023-130008

### DISCLOSURE OF THE INVENTION

### Problems to be Solved by the Invention

It is an object of the present invention to provide a hopper filling amount management system capable of easily and accurately determining a filling amount of garbage within a hopper.

### Means for Solving the Problems

A hopper filling amount management system according to an embodiment manages a filling amount of garbage within a hopper configured to receive the garbage loaded by a crane. The hopper filling amount management system includes an imaging apparatus configured to capture images of the hopper, and a management apparatus configured to calculate the filling amount based on the captured images output from the imaging apparatus. The management system includes a hopper filling amount detection section configured to set, as a reference image, a first captured image showing the hopper with no garbage loaded therein before operation, to create a difference image showing a difference between the reference image and a second captured image showing the hopper after start of the operation, and to calculate the filling amount based on the difference image.

### BRIEF DESCRIPTION OF THE DRAWINGS

FIG. 1 A schematic diagram showing a crane control system in a garbage disposal facility to which a hopper filling amount management system according to Embodiment 1 is applied.

FIG. 2 A block diagram showing the configuration of the crane control system including the hopper filling amount management system according to Embodiment 1.

FIG. 3 A diagram showing an example of processing of hopper filling amount detection according to Embodiment 1.

FIG. 4 A diagram for explaining crane control based on the processing of hopper filling amount detection according to Embodiment 1.

FIG. 5 A diagram showing a flow chart of the processing of hopper filling amount detection and the crane control according to Embodiment 1.

FIG. 6 A schematic diagram for explaining resetting of a reference image for use in difference image processing according to Embodiment 1.

FIG. 7 A diagram showing a flow chart of processing of hopper filling amount detection including the processing of resetting the reference image according to Embodiment 1.

### MODE FOR CARRYING OUT THE INVENTION

An embodiment of the present invention is hereinafter described with reference to the accompanying drawings.

### Embodiment 1

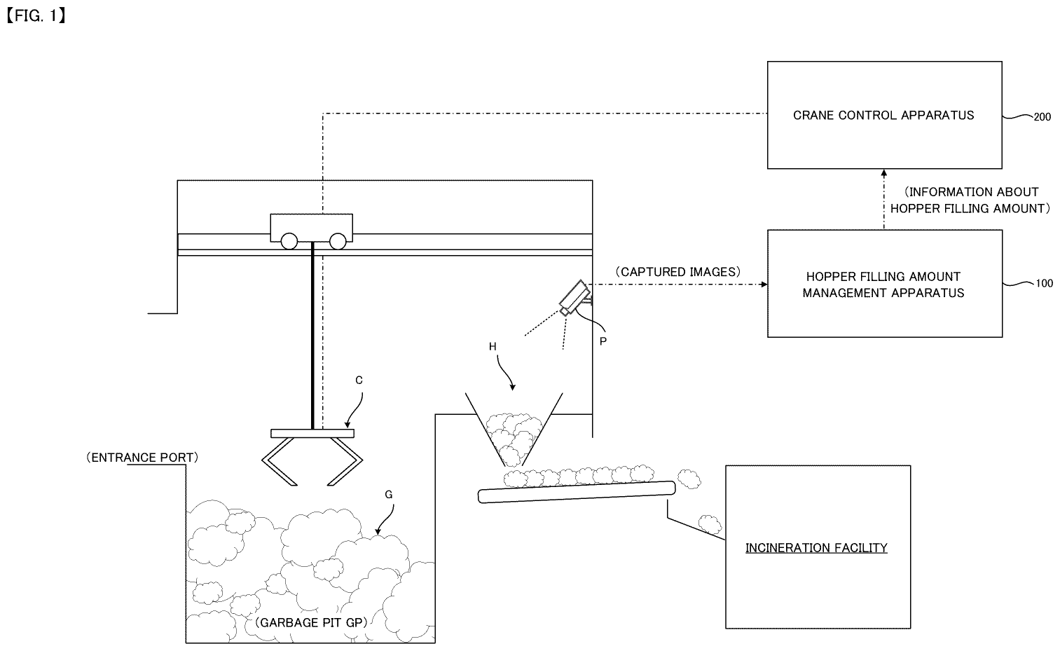

FIGS. 1 to 7 are diagrams for explaining Embodiment 1. FIG. 1 is a schematic diagram showing a crane control system in a garbage disposal facility to which a hopper filling amount management system according to Embodiment 1 is applied.

As shown in FIG. 1, garbage G carried into a garbage pit GP through an entrance port is loaded into a hopper H by a crane C. The hopper H is formed in the shape of four-sided pyramid tapered toward bottom and has an opened bottom face. The garbage loaded into the hopper H is passed through the opened bottom face to the next step by a carrier device such as a belt conveyor. An example of the next step is an incineration facility (incinerator). In addition to the carrier device such as the belt conveyor, a known technique can be used as appropriate to provide the mechanism to pass the garbage from the hopper H to the next step.

The crane control system in the garbage disposal facility includes a crane control apparatus 200 for controlling the garbage loading operation of the crane C. The crane control apparatus 200 automatically controls the loading operation of the crane C to the hopper H using information about hopper filling amount output from the hopper filling amount management system according to Embodiment 1.

The hopper filling amount management system includes an imaging apparatus P and a hopper filling amount management apparatus (hereinafter referred to as a management apparatus) 100. The imaging apparatus P is connected to the management apparatus 100 in a wireless or wired manner, and images (image data) captured by the imaging apparatus P are output from the imaging apparatus P to the management apparatus 100.

The imaging apparatus P includes an imaging device such as a CCD sensor or a CMOS sensor, captures images of the hopper H under monitoring, and outputs the image data. The captured images are 24-bit colored images in which R, G, and B elements of one pixel are each represented by 8 bits.

The hopper H can be imaged in a direction set appropriately to provide images which clearly show the filling status of garbage loaded in the hopper H. The imaging apparatus P is fixed and captures images of the hopper H from above at the same angle and in the same direction. The imaging apparatus P can provide still images and moving images of the hopper H and outputs those images to the management apparatus 100. When the imaging apparatus P captures moving images, a still image is cut out from the moving image and used as the image of the hopper H. It should be noted that an existing monitor camera for monitoring the hopper H in the garbage disposal facility is also used as the imaging apparatus P.

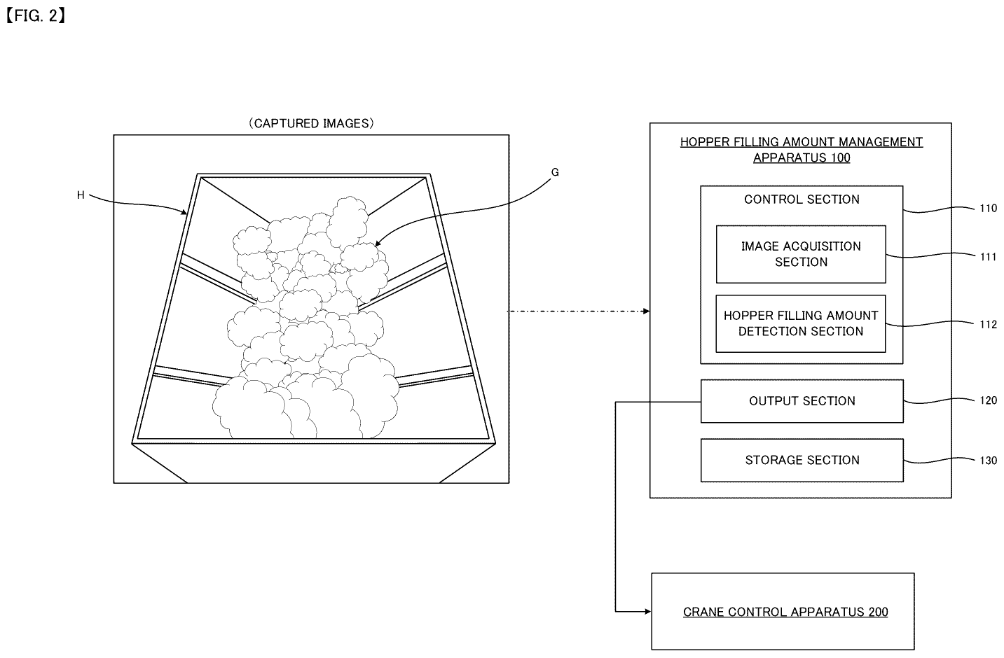

FIG. 2 is a block diagram showing the configuration of the crane control system including the hopper filling amount management system. As shown in FIG. 2, the management apparatus 100 serves as a monitoring apparatus for the crane control system and includes a control section 110, an output section 120, and a storage section 130. The management apparatus 100 is connected to the crane control apparatus 200 in a wireless or wired manner.

The control section 110 includes an image acquisition section 111 and a hopper filling amount detection section 112. The image acquisition section 111 can acquire the captured images from the imaging apparatus P and control the imaging operation of the imaging apparatus P. The image acquisition section 111 outputs the captured images received from the imaging apparatus P to the hopper filling amount detection section 112.

Specifically, the image acquisition section 111 outputs a first captured image showing the hopper H with no garbage loaded therein before operation to the hoper filling amount detection section 112 and outputs a second captured image showing the hopper H after the start of operation (for example, after the start of garbage loading) to the hopper filling amount detection section 112. The image acquisition section 111 sequentially outputs second captured images acquired at predetermined time intervals to the hopper filling amount detection section 112. The second captured images showing the hopper H after the start of operation are image data acquired sequentially over time in seconds or minutes.

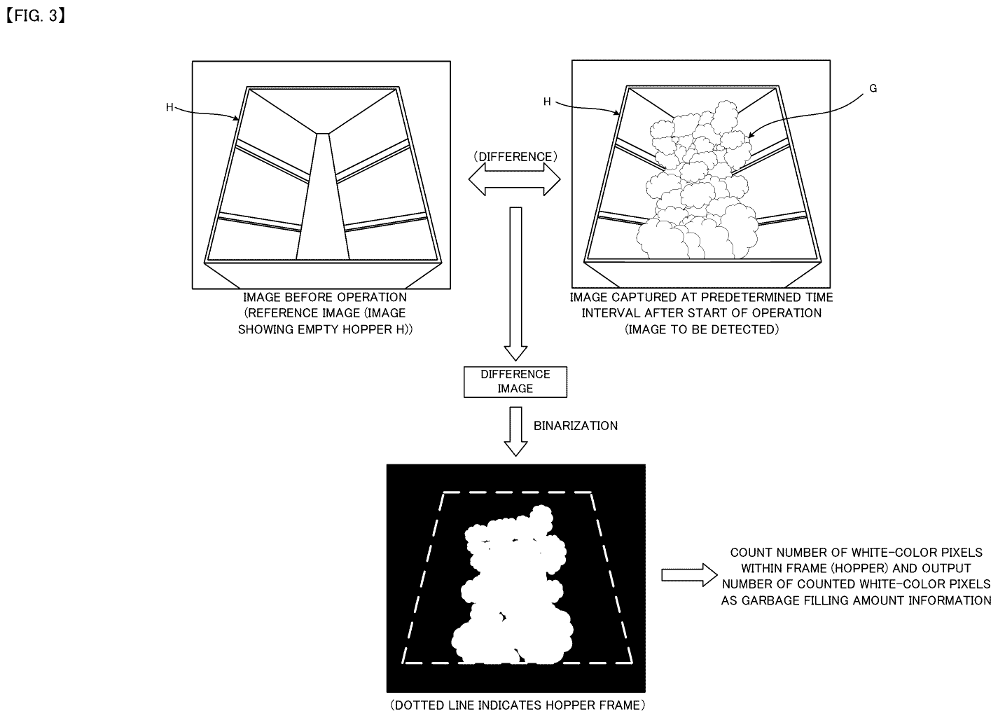

The hopper filling amount detection section 112 is a functional section for performing predetermined image processing to calculate a hopper filling amount from the captured images. FIG. 3 is a diagram showing an example of processing of hopper filling amount detection.

The processing of hopper filling amount detection according to Embodiment 1 includes setting, as a reference image, a captured image showing the empty hopper H with no garbage loaded therein before operation, and performing difference image processing of creating a difference image showing the difference between the set reference image and a captured image showing the hopper H after the start of operation. The filling amount is calculated based on the difference image.

The difference image processing includes calculating differences in pixel value (luminance value) at all pixel positions between the set reference image and the captured image showing the hopper H after the start of operation. The difference image is formed from the calculated difference values. In the difference image, a black portion corresponds to a pixel having a difference equal to zero, whereas a portion other than the black portion corresponds to a pixel having a difference not equal to zero. Thus, the garbage is represented by the pixels having differences from the pixels of the reference image showing the empty hopper H. Those pixels corresponding to the portion other than the black portion can be counted to calculate the filling amount of garbage within the hopper H. The difference value is the absolute value of difference in pixel value at each pixel position.

The hopper H has the four-sided pyramid as described above. The region (area) occupied by garbage determined from the difference image based on the captured images from above the hopper H can be considered as the filling amount in the hopper H (the volume of garbage present in the hopper H). A smaller garbage region corresponds to a lower filling amount, whereas a larger garbage region corresponds to a higher filling amount. In this manner, the garbage amount within the hopper H can be determined based on the difference image.

The hopper filling amount detection section 112 can converts the pixel values (luminance values) of the pixels in the difference image into grayscale image data with an average method to create a difference image in the grayscale. As shown in FIG. 3, the hopper filling amount detection section 112 can perform binarization of the difference image in the grayscale and count white-color pixels in the binarized difference image to calculate the filling amount. Such a configuration allows more accurate determination of the garbage present within the hopper H. Threshold values used in the binarization can be set as appropriate.

As described above, the processing of hopper filling amount detection according to Embodiment 1 includes the following three methods:
(A) The difference image processing includes the difference image processing of creating the difference image showing the difference between the reference image (color image) and the captured image (color image) showing the hopper H after the start of operation. The processing of hopper filling amount calculation includes counting the number of pixels representing garbage in the difference image to calculate the filling amount. In the difference image, the pixels having a difference not equal to zero can be extracted as pixels representing the garbage, or threshold values for RGB elements can be preset to identify the garbage such that pixels having a pixel value exceeding any of the threshold values can be extracted as pixels representing the garbage;
(B) The difference image processing includes the difference image processing of creating the difference image showing the difference between the reference image (color image) and the captured image (color image) showing the hopper H after the start of operation. Next, the difference image is converted into the grayscale image data to create the difference image in the grayscale. Finally, the difference image in the grayscale is subjected to binarization. The hopper filling amount calculation processing includes counting the number of white-color pixels in the binarized difference image to calculate the filling amount; and
(C) As a variation of (A) described above, the difference image processing includes the difference image processing of creating the difference image showing the difference between the reference image (color image) and the captured image (color image) showing the hopper H after the start of operation and then performing binarization of the difference image. The processing of hopper filling amount calculation includes counting the number of pixels representing garbage in the binarized image to calculate the filling amount. The binarization of the difference image can include, for example, setting the threshold values for the respective RGB elements of pixels, converting pixels having a pixel value exceeding any of the threshold values into white color, and converting pixels having a pixel value not exceeding any of the threshold values into black color. The processing of hopper filling amount calculation includes counting the number of white-color pixels in the binarized difference image to calculate the filling amount.

The hopper filling amount detection section 112 can preset a range in which it counts the pixels representing garbage. As shown in FIG. 3, the hopper filling amount detection section 112 can set a calculation region (defined by a white dotted line) corresponding to the frame of the hopper H preset in the captured image. The hopper filling amount detection section 112 can be configured to count the number of pixels representing the garbage present within the calculation region (pixels other than the black color, pixels exceeding any of the predetermined threshold values, or white-color pixels) to calculate the filling amount.

For example, the calculation region can be set together with the setting, as the reference image, the captured image showing the empty hopper H with no garbage loaded therein before operation. Since the imaging apparatus P has the fixed angle of view and direction, the calculation region, once set, can continue to be used without modification. The calculation region can be set manually. For example, the captured image (first captured image) representing the empty hopper H with no garbage loaded therein before operation can be shown on a display apparatus and an operator can define (draw) the calculation region along the frame of the hopper H with input means. The management apparatus 100 can provide the function of setting the calculation region.

The output section 120 is a functional section for outputting the hopper filling amount information created (detected) through the processing of hopper filling amount detection to the crane control apparatus 200. The crane control apparatus 200 can control the garbage loading operation of the crane based on the garbage filling amount in the hopper H received from the output section 120. The crane control apparatus 200 sequentially receives the input of hopper filling amount information changing over time.

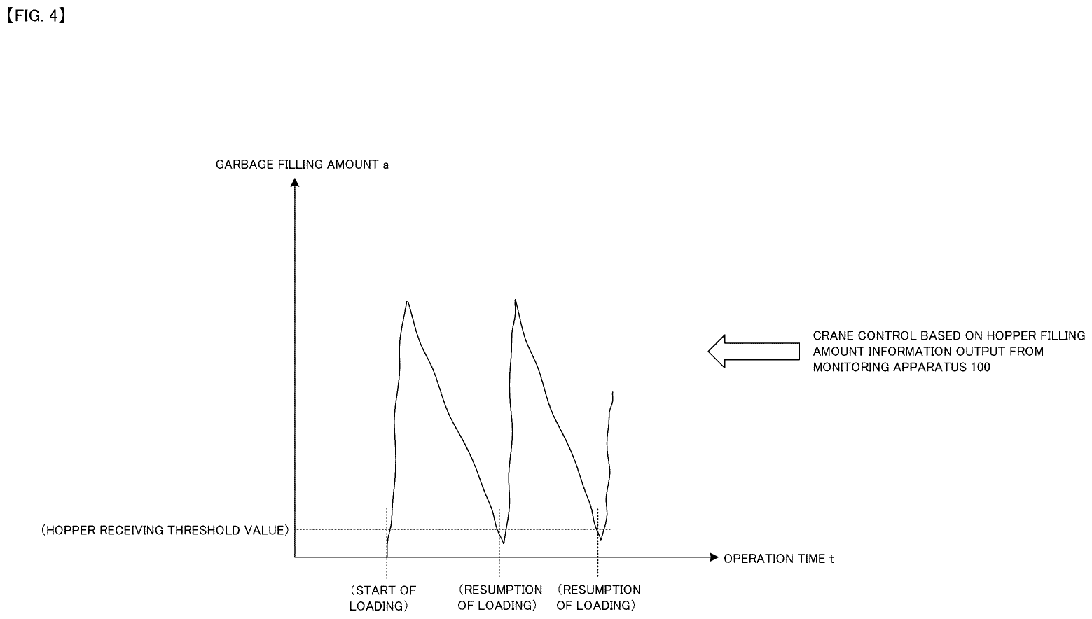

FIG. 4 is a diagram for explaining crane control based on the processing of hopper filling amount detection according to Embodiment 1. In a graph of FIG. 4, the Y axis indicates a garbage filling amount a, and the X axis indicates an operation time t.

After the start of operation, the crane control apparatus 200 causes the crane C to perform garbage loading operation including picking up garbage from the garbage pit GP and loading the garbage into the hopper H. During the garbage loading operation of the crane C, the garbage filling amount a within the hopper H increases each time garbage loading is performed. After each loading, the garbage filling amount a within the hopper H gradually reduces.

In Embodiment 1, after loading of garbage into the hopper H, the crane control apparatus 200 temporarily stops the garbage loading operation of the crane C to enter a stand-by state. Then, when the garbage filling amount a reduces to reach a hopper receiving threshold value, the crane control apparatus 200 causes the crane C to perform the garbage loading operation. In other words, the crane C is controlled to transition to the stand-by state after loading of garbage into the hopper H and to resume the loading of garbage when the garbage filling amount a reaches the hopper receiving threshold value. As described above, the crane control apparatus 200 can perform automatic control of the garbage loading operation of the crane C based on the hopper filling amount information output from the management apparatus 100 (hopper filling amount management system).

While description is made of the operation control of the crane C for the one hopper H, the present invention is not limited thereto. Some garbage disposal facilities include multiple hoppers H arranged side by side such that a single crane C loads garbage into those hoppers H in turn. For example, in a garbage disposal facility having two hoppers H1 and H2 installed, the management apparatus 100 can monitor and control the respective filling amounts in the hoppers H1 and H2. The hoppers H1 and H2 are provided with independent imaging apparatuses P1 and P2 which capture and input images of the associated hoppers to the management apparatus 100.

The management apparatus 100 can perform the processing of hopper filling amount detection on the captured images output from the imaging apparatuses P1 and P2 in parallel by using set reference images and captured images acquired after the start of operation to calculate and output filling amounts a1 and a2 in the hoppers H1 and H2 to the crane control apparatus 200.

The crane control apparatus 200 can automatically control the garbage loading operation of the crane C based on the filling amounts a1 and a2 in the hoppers H1 and H2. For example, after garbage is loaded into the hopper H1, garbage loading to the hopper H2 is performed. Then, the garbage loading operation of the crane C is temporarily stopped to enter and remain in a stand-by state until one of the garbage filling amount a1 within the hopper H1 and the garbage filling amount a2 within the hopper H2 reaches the hopper receiving threshold value. Since the garbage was loaded first into the hopper H1 in this case, the crane C is controlled to remain in the stand-by state until the garbage filling amount a1 reaches the hopper receiving threshold value. When the garbage filling amount a1 reaches the hopper receiving threshold value, the crane control apparatus 200 resumes the garbage loading to the hopper H1. As described above, when the garbage filling amount within one of the two hoppers H1 and H2 reaches the hopper receiving threshold value, the garbage loading of the crane C is resumed to that hopper of which the garbage filling amount has reached the hopper receiving threshold value, thereby repeating the hopper loading operation and the stand-by state.

While the imaging apparatuses P1 and p2 are provided for the hoppers H1 and H2, respectively, the present invention is not limited thereto. For example, a single imaging apparatus may capture a single image of the two hoppers H1 and H2, and the single image may be used to calculate two filling amounts within the hoppers H1 and H2.

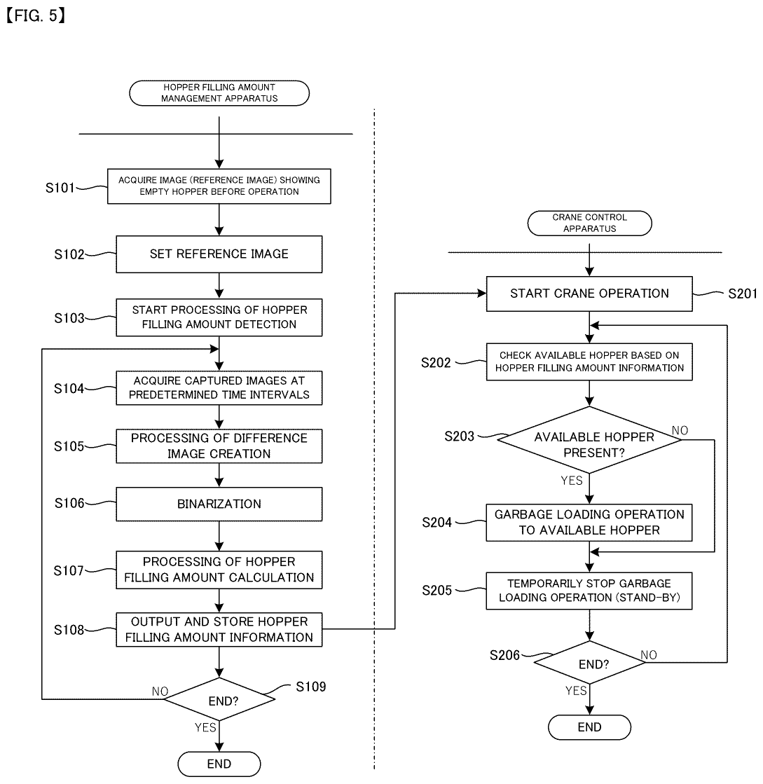

FIG. 5 is a diagram showing a flow chart of the processing of hopper filling amount detection and the crane control.

For operation of the crane control system in the garbage disposal facility, the management apparatus 100 acquires a captured image (first captured image) showing an empty hopper H with no garbage loaded therein before operation from the imaging apparatus P (S101) and sets the captured image as a reference image for use in difference image processing (S102).

The management apparatus 100 starts processing of hopper filling amount detection (S103) and acquires, from the imaging apparatus P, captured images (second captured image) showing the hopper P after the start of operation at predetermined time intervals (S104). The management apparatus 100 performs, on each of the captured images acquired sequentially over time, difference image processing (S105), binarization (S106), and processing of hopper filling amount calculation based on the number of pixels representing garbage to create hopper filling amount information (S107).

The created hopper filling amount information is output to the crane control apparatus 200 through the output section 120 (S108). The hopper filling amount information to be output is stored in the storage section 130. Upon end of the operation (stop of operation) of the crane control system in the garbage disposal facility (YES at S109), the management apparatus 100 ends the processing of hopper filling amount detection.

The crane control apparatus 200 starts the operation of the crane C (S201). After the start of the operation of the crane C, the crane control apparatus 200 checks whether or not an available hopper exists (or the hopper is available) based on the hopper filling amount information output from the management apparatus 100 (S202). Specifically, the crane control apparatus 200 checks the presence of the hopper H having a garbage filling amount equal to or lower than the hopper receiving threshold value. After checking of the presence of an available hopper H (or that the hopper H is available) (YES at S203), the crane control apparatus 200 controls the crane C to perform garbage loading to the available hopper H (S204). The crane control apparatus 200 temporarily stops the garbage loading of the crane C to that hopper H (S205). Until the end of the operation, the crane control apparatus 200 repeatedly performs steps S202 to S205. Upon end of the operation (YES at S206), the crane control apparatus 200 ends the garbage loading control of the crane C.

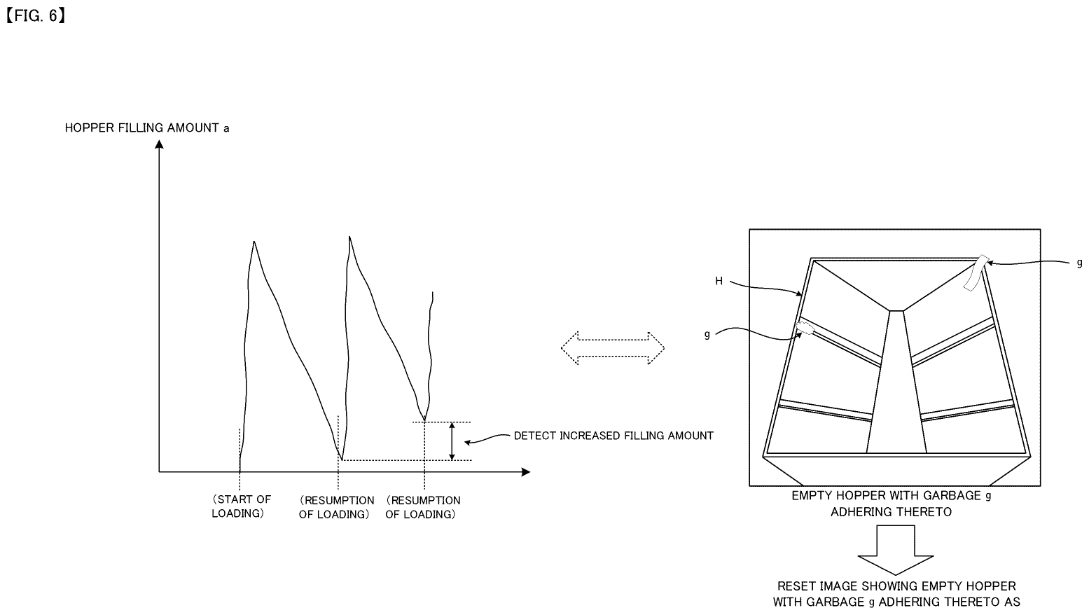

FIG. 6 is a schematic diagram for explaining a function of resetting a reference image for use in difference image processing.

The reference image used in the processing of hopper filling amount detection according to Embodiment 1 can be provided by using a captured image showing the empty hopper H before operation of the crane control system in the garbage disposal facility, and the processing of hopper filling amount detection can be performed thereafter without changing the reference image.

As shown on the right of FIG. 6, garbage g loaded into the hopper H may get caught on the wall face of the hopper H or dirt may adhere to the hopper H to change the empty hopper H from its state before operation. In this case, difference image processing may erroneously detect the caught garbage g or the adhering dirt as garbage loaded in the hopper H to thereby calculate an increased filling amount. As shown on the left of FIG. 6, although the garbage filling amount a gradually reduces after the stop of garbage loading, the lowest value of garbage filling amount is shifted upward when the garbage gets caught on the wall face of the hopper H or dirt adheres to the hopper H. The upward shift of the lowest value of the garbage filling amount shortens the time to reach the loading stop threshold, which reduces the efficiency of garbage loading to the hopper H.

To address this, the hopper filling amount detection section 112 according to Embodiment 1 has a function of resetting, as the reference image, a captured image (third captured image) acquired from the imaging apparatus P at a predetermined time after the start of operation to prevent the upward shift of the lowest value of the garbage filling amount, in other words, prevent the detection of the increased filling amount even when the hopper can fully receive garbage.

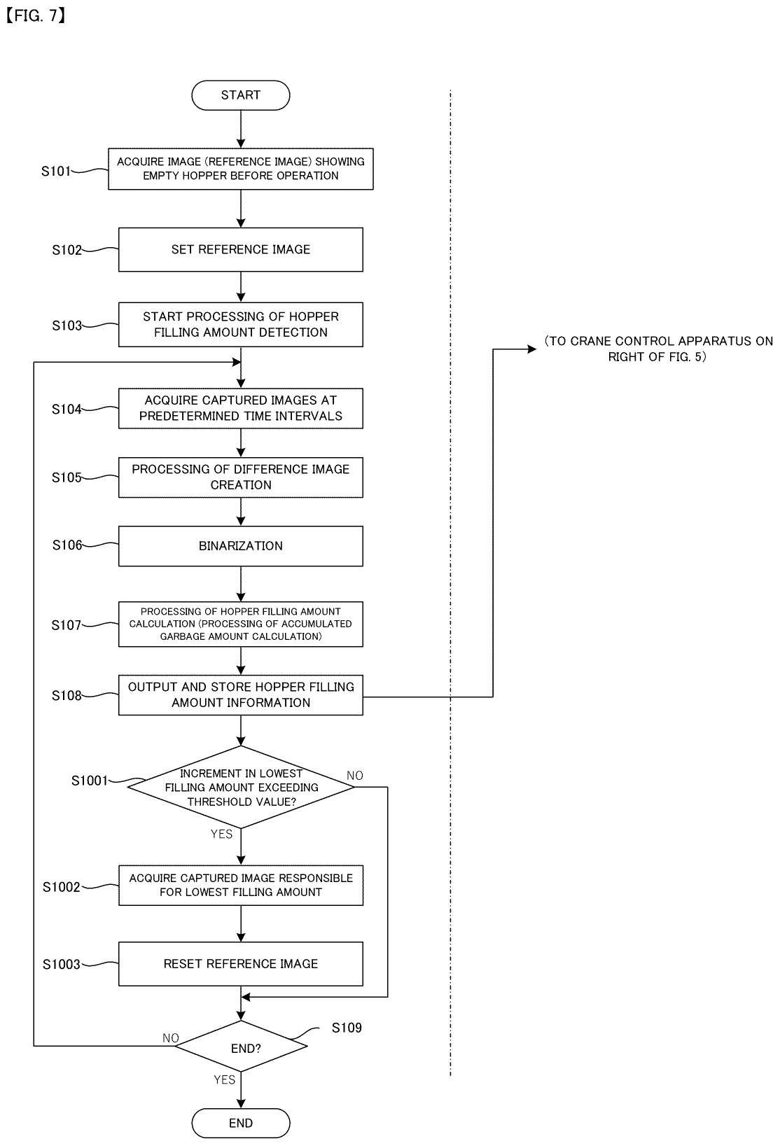

FIG. 7 is a diagram showing a flow chart of processing of hopper filling amount detection including the processing of resetting the reference image according to Embodiment 1. It should be noted that the processing operations similar to those in FIG. 5 are designated with the same reference numerals as those in FIG. 5 and description thereof is omitted.

As shown in FIG. 7, at step S102, the hopper filling amount detection section 112 sets a captured image representing an empty hopper H before operation as a reference image and starts processing of hopper filling amount detection. At steps S1001 to S1003, processing of resetting the reference image can be performed. The hopper filling amount detection section 112 resets, as a reference image, a captured image (third captured image) acquired from the imaging apparatus P at a predetermined time after the start of operation, and the reset reference image is used to perform the following processing of hopper filling amount detection (difference image processing).

Specifically, when the lowest value of the filling amount calculated from the difference image created based on the currently set reference image (first captured image) has changed by an increment exceeding a predetermined threshold value (S1001), the hopper filling amount detection section 112 acquires the captured image (third captured image) at the lowest value shifted upward beyond the predetermined threshold value (S1002). For example, the hopper filling amount detection section 112 can acquire the captured image representing the empty hopper H although garbage g gets caught on the wall face of the hopper H or dirt adheres to the hopper H. The hopper filling amount detection section 112 resets that captured image acquired during the operation as the reference image for use in the difference image processing (S1003) and performs the following processing of filling amount calculation.

With reference to the example graph of FIG. 6 showing the garbage filling amount a changing over time, the point at which the filling amount a transitions from decrease to increase corresponds to the lowest value of the garbage filling amount g in the hopper H. The hopper filling amount detection section 112 monitors the lowest value over time to determine whether or not the lowest value has changed by an increment exceeding the predetermined threshold value (S1001). Specifically, the hopper filling amount detection section 112 can determine that the increment in the lowest value exceeds the predetermined threshold value by detecting that the lowest value does not decrease to a predetermined value or lower.

When the increment in the lowest value exceeds the predetermined threshold value, the hopper filling amount detection section 112 acquires the captured image at the lowest value which has changed by the increment exceeding the predetermined threshold value. The hopper filling amount detection section 112 resets, as the reference image, that captured image at the lowest value which has changed by the increment exceeding the predetermined threshold value and then performs the processing of hopper filling amount detection described above including the difference image processing.

While description is made of the aspect in which the function of resetting the reference image for use in the difference image processing is performed when the lowest value of the garbage filling amount a has changed by the increment exceeding the predetermined threshold value, the present invention is not limited thereto. For example, the reference image may be reset automatically at a certain time (at a particular time or at predetermined time intervals). In addition, an operator who monitors the hopper H may input an instruction for reset at any time to perform the function of reference image resetting.

The increment serves as information representing how much the current lowest value has changed from the reference lowest value. When the increment is more than the predetermined threshold value above the reference lowest value, the reference image can be reset. The reference lowest value can be set, for example, by calculating the minimum value from data about garbage filling amount a on the previous day and using the minimum value as the reference lowest value. The minimum value can be calculated in various methods. For example, one such method includes extracting data about garbage filling amount a during the operating hours of the previous day, calculating the mean value and the standard deviation, subtracting twice the standard deviation from the mean value (mean value −2σ), then removing data equal to or less than the mean value −2σ from the data about garbage filling amount a during the operating hours of the previous day (removal of outliers), and setting, as the reference value, the minimum value of the garbage filling amount a of the data about garbage filling amount a during the operating hours of the previous day after the removal of outliers. Another method may include calculating, as the reference lowest value, the minimum value of the garbage amount a acquired during operation, for example, the minimum value of the garbage filling amount a in the time period of the last three hours.

As described above, when the lowest value of the garbage filling amount a during the operation deviates from the reference lowest value by the predetermined magnitude or more, that is, exhibits the increment of the predetermined threshold value or more, the reference image can be changed to prevent reduced efficiency in garbage loading to the hopper H.

According to Embodiment 1, the difference image can be used to easily and correctly determine the filling amount within the hopper H.

Conventionally, a contact-type sensor has been installed within the hopper H to find the upper limit of a filling amount, or a distance measuring sensor or parallax-based height measurement using two cameras has been utilized to determine the filling amount of garbage. The former has an issue of malfunction (erroneous detection) if garbage adheres to the contact-type sensor. The latter requires measurement of distance or height, which presents not a few issues yet to be resolved in terms of complicated structure and high cost.

In contrast, the hopper filling amount management system according to Embodiment 1 can correctly determine the garbage filling amount within the hopper H only by performing the simplified image processing including the difference image processing on the captured images acquired from the imaging apparatus P and thus achieve the extremely simple system configuration.

Particularly, the garbage filling amount can be determined only through the difference image processing or only through the difference image processing and the binarization without using representative AI technologies in the field of image processing, so that the processing can be performed with low processing load and at high speed. This eliminates the need to use high-spec CPUs or memory in a computer apparatus to reduce the cost as a whole.

For example, when a typical AI technology is used for identification in image processing, an identifier needs to learn a target in training data. Specifically, manual annotation is required to identify whether a region in an image represents garbage or another object for segmentation, or to indicate whether the whole image is usable or not for image classification. To perform image recognition with an AI model in real time, a high-spec computing apparatus such as GPU is essential, so that the specifications of the computer apparatus affect the processing or the computer apparatus inevitably involves high cost.

As described above, the hopper filling amount management apparatus according to Embodiment 1 can achieve work saving in the computer apparatus (computer system).

In the crane control system according to Embodiment 1, the crane control apparatus 200 controls the crane C to enter the stand-by state after garbage loading into the hopper H and to resume loading into the hopper H when the filling amount after the stop of loading falls to the hopper receiving threshold value.

Conventionally, the garbage loading operation of the crane C is stopped when the filling amount within the hopper H reaches the loading stop threshold value, that is, the upper limit of the filling amount within the hopper H. In contrast, the crane control system according to Embodiment 1 temporarily stops the crane C automatically after the garbage loading operation and resumes the garbage loading operation in response to the garbage filling amount falling to the hopper receiving threshold value.

For example, as shown in FIG. 4 and FIG. 6, the crane control system can trace the waveform showing that the garbage filling amount in the hopper H decreases after the garbage is carried to the next step and increases after new garbage is loaded by the crane C. The crane control system can set the loading timing at the lowest value of the waveform, that is, the hopper receiving threshold value, to control the timing of garbage loading of the crane C to the hopper H, thereby appropriately determining whether new garbage can be loaded or not without requiring manual teaching operation or parameter adjustment operation.

While Embodiment 1 has been described above, the apparatuses 100 and 200 are computer apparatuses provided with a computing function, a storage function, a communication function and the like. The apparatuses 100 and 200 can include, as hardware configuration, memory (main storage apparatus), operation input means such as a mouse, a keyboard, a touch panel, and a scanner, output means such as a printer, and an auxiliary storage apparatus (such as hard disk).

The functions of the present invention can be implemented by a program. A computer program previously provided for implementing the functions can be stored on an auxiliary storage apparatus, the program stored on the auxiliary storage apparatus can be read by a control section such as a CPU to a main storage apparatus, and the program read to the main storage apparatus can be executed by the control section to cause the computer to provide the functions of the respective components according to the present invention.

The program may be recorded on a computer readable recording medium and provided for the computer. Examples of the computer readable recording medium include optical disks such as CD-ROMs and rewritable Blue-Ray® Disks, phase-change optical disks such as DVD-ROMs, magneto-optical disks such as Magnet-Optical (MO) disks, magnetic disks such as floppy Disks® and hard disks, and memory cards such as SD memory cards and USB flash drives. Hardware apparatuses such as integrated circuits (such as IC chips for ROM or RAM) designed and configured specifically for the purpose of the present invention are included in the recording medium.

The present invention including the above program is not limited to implementation on an architecture of von Neumann computer, and may be implemented on an architecture of non-von Neumann computer such as a neurocomputer based on the mechanism of cranial nerve circuits or a quantum computer based on quantum mechanics applied to information processing.

While the exemplary embodiment of the present invention has been described above, the embodiment is only illustrative and is not intended to limit the scope of the present invention. The novel embodiment can be implemented in various other forms, and various omissions, substitutions, and modifications can be made thereto without departing from the spirit or scope of the present invention. These embodiments and variations are encompassed within the spirit or scope of the present invention and within the invention set forth in the claims and the equivalents thereof.

### DESCRIPTION OF THE REFERENCE NUMERALS

100 MONITORING APPARATUS (HOPPER FILLING AMOUNT MANAGEMENT APPARATUS)
110 CONTROL SECTION
111 IMAGE ACQUISITION SECTION
112 HOPPER FILLING AMOUNT DETECTION SECTION
120 OUTPUT SECTION
130 STORAGE SECTION
200 CRANE CONTROL APPARATUS
P IMAGING APPARATUS
H HOPPER
C CRANE
G, g GARBAGE

1. A hopper filling amount management system for managing a filling amount of garbage within a hopper configured to receive the garbage loaded by a crane, comprising:
an imaging apparatus configured to capture images of the hopper; and
a management apparatus configured to calculate the filling amount based on the captured images output from the imaging apparatus,
wherein the management apparatus includes a hopper filling amount detection section configured to set, as a reference image, a first captured image showing the hopper with no garbage loaded therein before operation, to create a difference image showing a difference between the reference image and a second captured image showing the hopper after start of the operation, and to calculate the filling amount based on the difference image.

2. The hopper filling amount management system according to claim 1, further comprising an output section configured to output the filling amount to a crane control apparatus configured to control garbage loading operation of the crane based on the filling amount.

3. The hopper filling amount management system according to claim 1, wherein the hopper filling amount detection section is configured to perform binarization of the created difference image, to count white-color pixels in the binarized difference image, and to calculate the filling amount.

4. The hopper filling amount management system according to claim 3, wherein the hoper filling amount detection section is configured to count the white-color pixels present within a calculation region for the filling amount, the calculation region corresponding to a hopper frame preset in the captured image, and to calculate the filling amount.

5. The hopper filling amount management system according to claim 1, wherein the hopper filling amount detection section is configured to allow resetting of a third captured image as the reference image, the third captured image showing the hopper during the operation and being acquired from the imaging apparatus after the start of the operation.

6. The hopper filling amount management system according to claim 5, wherein the hopper filling amount detection section is configured to reset, when a lowest value of the filling amount calculated from the difference image created based on the first captured image has changed by an increment exceeding a predetermined threshold value, the third captured image at the lowest value as the reference image, to create the difference image using the reset reference image, and to calculate the filling amount.

7. A non-transitory computer readable medium including a computer executable program comprising computer executable instructions for managing a filling amount of garbage within a hopper configured to receive the garbage loaded by a crane, wherein the instructions, when executed by a computer, causes the computer to provide:
a function of setting, as a reference image, a first captured image showing the hopper with no garbage loaded therein before operation, the first captured image being acquired by an imaging apparatus configured to capture images of the hopper, creating a difference image showing a difference between the reference image and a second captured image showing the hopper after start of the operation, and calculating the filling amount based on the difference image.

8. A crane control system for use in a garbage disposal facility and for detecting a filling amount of garbage within a hopper configured to receive the garbage loaded by a crane in the garbage disposal facility and controlling garbage loading operation of the crane based on the filling amount, comprising:
an imaging apparatus configured to capture images of the hopper;
a management apparatus configured to calculate the filling amount based on the captured images output from the imaging apparatus; and
a crane control apparatus configured to control the garbage loading operation of the crane based on the filling amount,
wherein the management apparatus includes:
a hopper filling amount detection section configured to set, as a reference image, a first captured image showing the hopper with no garbage loaded therein before operation, to create a difference image showing a difference between the reference image and a second captured image showing the hopper after start of the operation, and to calculate the filling amount based on the difference image; and
an output section configured to output the filling amount to the crane control apparatus configured to control the garbage loading operation of the crane, and
wherein the crane control apparatus is configured to temporarily stop the garbage loading operation after the garbage loading to the hopper and to resume the garbage loading operation to the hopper when the filling amount falls below a predetermined threshold after the stop of the garbage loading or when the filling amount reaches the predetermined threshold after the stop of the garbage loading.

9. The hopper filling amount management system according to claim 2, wherein the hopper filling amount detection section is configured to perform binarization of the created difference image, to count white-color pixels in the binarized difference image, and to calculate the filling amount.

10. A hopper filling amount management method for managing a filling amount of garbage within a hopper configured to receive the garbage loaded by a crane, comprising:
capturing, by an imaging apparatus, images of the hopper; and
calculating, by a management apparatus, the filling amount based on the captured images output from the imaging apparatus,
wherein the calculating by the management apparatus includes setting, by a hopper filling amount detection section, as a reference image, a first captured image showing the hopper with no garbage loaded therein before operation, to create a difference image showing a difference between the reference image and a second captured image showing the hopper after start of the operation, and to calculate the filling amount based on the difference image.

11. A crane control method for use in a garbage disposal facility and for detecting a filling amount of garbage within a hopper configured to receive the garbage loaded by a crane in the garbage disposal facility and controlling garbage loading operation of the crane based on the filling amount, comprising:
capturing, by an imaging apparatus, images of the hopper;
calculating, by a management apparatus, the filling amount based on the captured images output from the imaging apparatus; and
controlling, by a crane control apparatus, the garbage loading operation of the crane based on the filling amount,
wherein the calculating by the management apparatus includes:
setting, by a hopper filling amount detection section, as a reference image, a first captured image showing the hopper with no garbage loaded therein before operation, to create a difference image showing a difference between the reference image and a second captured image showing the hopper after start of the operation, and to calculate the filling amount based on the difference image; and
outputting, by an output section, the filling amount to the crane control apparatus configured to control the garbage loading operation of the crane; and
further comprising temporarily stopping the garbage loading operation after the garbage loading to the hopper and resuming the garbage loading operation to the hopper when the filling amount falls below a predetermined threshold after the stopping of the garbage loading or when the filling amount reaches the predetermined threshold after the stopping of the garbage loading.
